(19) United States
(12) Patent Application Publication
(10) Pub. No.: US 2017/0338517 A1
(43) Pub. Date: Nov. 23, 2017

(54) ALL SOLID-STATE BATTERY

(71) Applicant: HYUNDAI MOTOR COMPANY, Seoul (KR)

(72) Inventors: Oh Min KWON, Busan (KR); Yong Sub YOON, Seoul (KR); Kyung Su KIM, Yongin-si (KR); Hong Seok MIN, Yongin-si (KR)

(21) Appl. No.: 15/373,144

(22) Filed: Dec. 8, 2016

(30) Foreign Application Priority Data
May 19, 2016 (KR) 10-2016-0061539

(51) Int. Cl. H01M 10/0585

(52) U.S. Cl. CPC H01M 10/0585

(57) ABSTRACT

An all solid-state battery is formed of slurry of an electrode/electrolyte/conductive material composite. An outer circumferential surface of the conductive material is coated with a solid electrolyte to form a solid electrolyte layer. Since the surface of the conductive material is coated with a solid electrolyte, contact characteristics between the conductive material and the solid electrolyte and between the conductive material and an electrode can be maximized. Also, since the surface of the conductive material having a large surface area is coated with the solid electrolyte, an ion conductor, the conductive material may be given ion conductivity, as well as electronic conductivity, facilitating securing of an ion conduction path. In addition, since the conductive material having a large surface area is coated with the solid electrolyte, a proportion of the solid electrolyte to the composite may be reduced.

### CROSS-REFERENCE TO RELATED APPLICATION

This application is based on and claims the benefit of priority to Korean Patent Application No. 10-2016-0061539, filed on May 19, 2016, in the Korean Intellectual Property Office, the disclosure of which is incorporated herein in its entirety by reference.

### TECHNICAL FIELD

The present disclosure relates to an all solid-state battery, and more particularly, to an all solid-state battery capable of reducing a proportion of a solid electrolyte to an electrode/solid electrolyte/conductive material composite, as well as providing both electronic conductivity and ion conductivity.

### BACKGROUND

As social demand for realization of green vehicles has grown, so-called hybrid vehicles using a combination of an internal combustion engine and an electric motor as a driving source or electric vehicles using an electric motor as a driving source, rather than vehicles using an internal combustion engine based on conventional gasoline or diesel as primary fuel, as a driving source, have been developed, and some of the vehicles have been commercialized and sold as on-sale vehicles.

Secondary storage batteries that can be charged or discharged are indispensable to hybrid vehicles or electric vehicles to drive an electric motor, but related art secondary storage batteries, represented by lithium ion batteries, mostly use a liquid electrolyte, involving a problem of liquid leakage.

Also, lithium ion batteries are a power source of portable devices such as notebook computers or mobile phones, and as such, lithium ion batteries have been commonly employed but with frequent reports of accidents such as ignition or damage. In particular, compared with secondary storage batteries installed in portable devices, secondary storage batteries installed in vehicles are required to be operated under harsher conditions and have increased energy capacity, and thus, necessity of securing safety is urgent.

Thus, the development of all solid-state batteries in which all the primary members including an electrolyte are formed of a solid has been in progress. Since an electrolyte of an all solid-state battery is not a liquid, a possibility of liquid leakage, ignition, and damage is considerably reduced, compared with the related art secondary storage batteries.

All solid-state batteries are battery systems replacing an organic electrolyte of commercial all solid-state batteries with a solid electrolyte, realizing high energy and high output density, as well as high safety, using a material having high conductivity and flame resistance.

However, in a sulfide all solid-state battery system, solid-solid contact is not smoothly made, reducing an output and energy density.

Also, in an all solid-state battery system, a problem of inter-particle contact arises in a solid electrolyte/solid electrolyte, solid electrolyte/conductive material, solid electrolyte/electrode, and conductive material/electrode. Among them, a conductive material has a relatively large surface area, and thus, when an electrode/solid electrolyte/conductive material composite is manufactured, a state of a surface of the conductive material may considerably affect battery performance.

In addition, when slurry of an electrode/solid electrolyte/conductive material is prepared, the conductive material may easily cohere and may not be easily dispersed in a solvent.

### SUMMARY

The present disclosure has been made to solve the above-mentioned problems occurring in the prior art while advantages achieved by the prior art are maintained intact.

An aspect of the present disclosure provides an all solid-state battery in which a surface of a conductive material is uniformly coated to form an ion conduction path between electrode components by using a solid electrolyte, rather than a liquid electrolyte.

Technical subjects of the present invention are not limited to the foregoing technical subjects and any other technical subjects not mentioned herein may be easily understood by a person skilled in the art from the present disclosure and accompanying drawings.

According to an exemplary embodiment of the present disclosure, an all solid-state battery is formed of slurry of an electrode/electrolyte/conductive material composite. An outer circumferential surface of the conductive material is coated with a solid electrolyte to form a solid electrolyte layer.

The solid electrolyte layer may be uniformly coated by at least one of a spray method and a wet coating method.

A thickness of the solid electrolyte layer may range from 10 to 50 μm.

Details of exemplary embodiments are included in detailed descriptions and drawings.

### BRIEF DESCRIPTION OF THE DRAWINGS

The above and other objects, features and advantages of the present disclosure will be more apparent from the following detailed description taken in conjunction with the accompanying drawings.

FIG. 1 is a cross-sectional view illustrating an all solid-state battery according to an exemplary embodiment of the present disclosure.

FIGS. 2A and 2B are views illustrating coated conductive materials according to an exemplary embodiment of the present disclosure.

FIGS. 3A and 3B are views illustrating a related art conductive material and a coated conductive material according to an exemplary embodiment of the present disclosure, respectively.

### DETAILED DESCRIPTION

Advantages and features of the present invention and implementation methods thereof will be clarified through following exemplary embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Further, the present invention is only defined by scopes of claims. Throughout the specification, like numbers refer to like elements.

Hereinafter, an all solid-state battery according to exemplary embodiments of the present disclosure will be described with reference to the accompanying drawings.

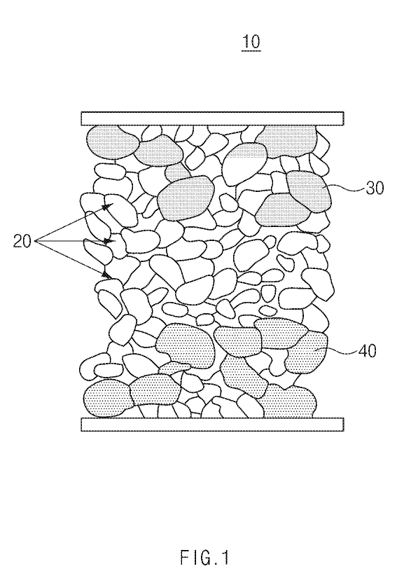

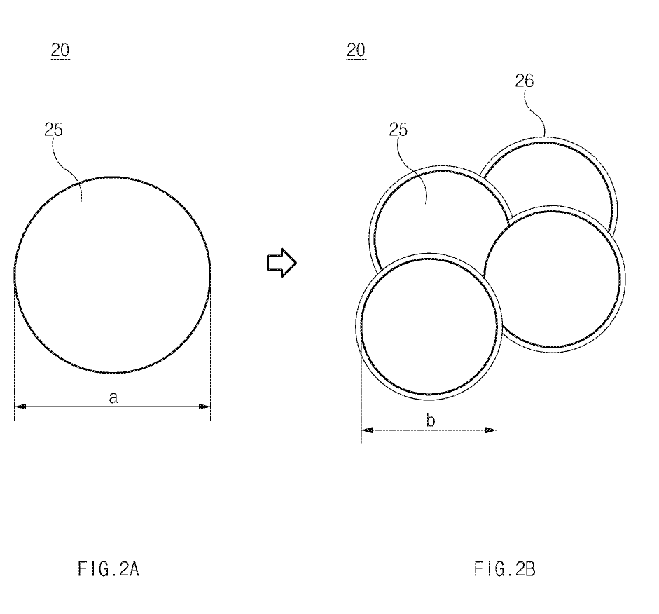

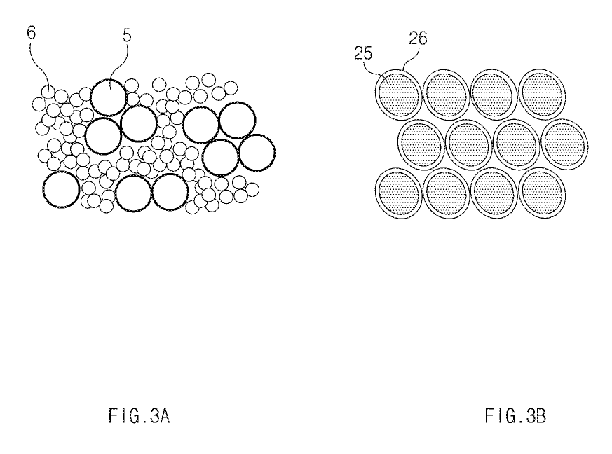

FIG. 1 is a cross-sectional view illustrating an all solid-state battery according to an exemplary embodiment of the present disclosure, FIGS. 2A and 2B are views illustrating coated conductive materials according to an exemplary embodiment of the present disclosure, and FIGS. 3A and 3B are views illustrating a related art conductive material and a coated conductive material according to an exemplary embodiment of the present disclosure, respectively.

A preferred all solid-state battery of a vehicle may be modified by a person skilled in the art, and it is an all solid-state battery in the present exemplary embodiment.

An all solid-state battery according to an exemplary embodiment of the present disclosure will be described with reference to FIGS. 1 to 3B. In an all solid-state battery formed of slurry of an electrode/electrolyte/conductive material composite, a solid electrolyte layer 26 is formed by coating an outer circumferential surface of a conductive material 25 with a solid electrolyte.

A positive electrode active material contained in a positive electrode is not particularly limited as long as it can reversibly occlude and discharge a lithium ion. The positive electrode active material may be, for example, cobalt lithium oxide, nickel lithium oxide, nickel cobalt lithium oxide, nickel cobalt aluminum lithium oxide, nickel cobalt manganese lithium oxide, manganese lithium oxide, lithium iron phosphate, nickel sulfide, copper sulfide, sulfur, iron oxide, vanadium oxide, and the like. These positive electrode active materials may be used alone or two or more types thereof may be used together.

The solid electrolyte layer 26 is formed by coating an outer circumferential surface of the conductive material 25 with a solid electrolyte 20. The solid electrolyte layer 26 may be uniformly coated through at least one of a spray method and a wet coating method. A coating of the solid electrolyte layer 26 has a thickness ranging from 10 to 50 μm. Thus, a thickness of a diameter b obtained by adding the solid electrolyte layer 26 to a diameter a of the conductive material 25 should include 10 to 50 μm.

Thus, since the conductive material 25 is coated with the solid electrolyte 20, the conductive material is stabilized during an electrochemical reaction, and since the solid electrolyte, an electrode, and surface energy are modified to the same or equal level to improve contact characteristics between the conductive material and the solid electrolyte and between the conductive material and the electrode.

Also, since the conductive material, an electronic conductor, is coated with the solid electrolyte, an ion conductor, both electronic conductivity and ion conductivity are provided, and since a proportion of the solid electrolyte to the electrode/solid electrolyte/conductive material composite is reduced, excellent output and high energy density can be obtained.

Also, the conductive material is coated with the solid electrolyte to allow the conductive material coated with the solid electrolyte to be dispersed more easily than the conductive material without solid electrolyte coated thereon. When slurry of the electrode/solid electrolyte/conductive material composite is prepared, the conductive material coated with the solid electrolyte may be more evenly dispersed, obtaining high quality slurry.

As illustrated in FIG. 3A, a ratio between a positive electrode 30 and an electrolyte according to the related art is 70:30, but, as illustrated in FIG. 3B, a ratio between the positive electrode and the electrolyte in the coating of the electrolyte with respect to the positive electrode is adjusted to 95:5, whereby energy density is enhanced due to an increase in the loading amount of the positive electrode.

An operation of the all solid-state battery according to an exemplary embodiment of the present disclosure configured as described above will be described.

Referring to FIGS. 1 to 3B, the all solid-state battery according to an exemplary embodiment of the present disclosure uses a solid electrolyte, rather than a liquid electrolyte, an ion conduction path should be formed between electrode components. Since the battery is driven according to contact between solids, contact between an electrode and an electrolyte and between conductive material and an electrolyte should be considered.

Output characteristics are changed according to a proportion of a solid electrolyte forming an electrode, and here, large content of the solid electrolyte causes high loss of energy density, the proportion of the solid electrolyte should be reduced.

Thus, since the solid electrolyte is used instead of a liquid electrolyte, high contact may be considered even without using a separator and loss is reduced. In addition, output characteristics are varied according to proportions of the solid electrolyte forming the electrode.

As described above, the all solid-state battery according to an exemplary embodiment of the present disclosure has one or more advantages as follows.

First, according to the all solid-state battery according to an exemplary embodiment of the present disclosure, since the surface of the conductive material is coated with a solid electrolyte, contact characteristics between the conductive material and the solid electrolyte and between the conductive material and an electrode can be maximized.

Second, according to the all solid-state battery according to an exemplary embodiment of the present disclosure, since the surface of the conductive material having a large surface area is coated with the solid electrolyte, an ion conductor, the conductive material may be given ion conductivity, as well as electronic conductivity, facilitating securing of an ion conduction path.

Third, according to the all solid-state battery according to an exemplary embodiment of the present disclosure, since the conductive material having a large surface area is coated with the solid electrolyte, a proportion of the solid electrolyte to the composite may be reduced.

Fourth, according to the all solid-state battery according to an exemplary embodiment of the present disclosure, since ion and electronic paths are maximized, a positive electrode may be easily formed to be thick.

Fifth, according to the all solid-state battery 10 according to an exemplary embodiment of the present disclosure, since the conductive material is coated with the solid electrolyte which is easily dispersed in a solvent, the solid electrolyte may be evenly dispersed in preparing slurry, whereby high quality slurry with the conductive material evenly disposed therein may be prepared.

Advantages and effects of the present disclosure that may be obtained in the present disclosure are not limited to the foregoing effects and any other technical effects not mentioned herein may be easily understood by a person skilled in the art from the present disclosure and accompanying drawings.

As for the all solid-state battery according to the present disclosure, the configuration and method according to the exemplary embodiments of the present disclosure described above are not limited in its application, but the entirety or a portion of the exemplary embodiments may be selectively combined to be configured into various modifications.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An all solid-state battery formed of slurry of an electrode/electrolyte/conductive material composite,
wherein an outer circumferential surface of the conductive material is coated with a solid electrolyte to form a solid electrolyte layer.

2. The all solid-state battery according to claim 1, wherein the solid electrolyte layer is uniformly coated by at least one of a spray method and a wet coating method.

3. The all solid-state battery according to claim 1, wherein a thickness of the solid electrolyte layer ranges from 10 to 50 μm.

4. The all solid-state battery according to claim 1, containing no liquid electrolyte.
